(19) United States
(12) Patent Application Publication
(10) Pub. No.: US 2026/0149941 A1
(43) Pub. Date: May 28, 2026

(54) AUDIO SPATIAL COMPLEXITY SCORING OF CONTENT ITEMS ON DIGITAL CONTENT PLATFORMS

(71) Applicant: Roku, Inc., San Jose, CA (US)

(72) Inventors: Frank Llewellyn Maker, Livermore, CA (US); Sunil Ramesh, Saratoga, CA (US); Robert Caston Curtis, Napa, CA (US); David Henry Friedman, Austin, TX (US); Kasper Andersen, Aarhus (DK)

(73) Assignee: Roku, Inc., San Jose, CA (US)

(21) Appl. No.: 18/958,248

(22) Filed: Nov. 25, 2024

(51) Int. Cl. H04S 7/00; H04S 1/00

(52) U.S. Cl. CPC H04S 7/302; H04S 1/007; H04S 7/308; H04S 2400/11

(57) ABSTRACT

Surround sound systems can dramatically expand the size of a user's sound field. Much surround sound content is mixed in a simplistic way where the front audio is copied to the rear, at a lower volume. It can be difficult for users to appreciate the value proposition of a surround sound system without more compelling spatially complex content. Quantifying surround sound complexity of various content items based on an audio spatial complexity scoring system can address this issue. Algorithms can be implemented to determine an audio spatial complexity score based on audio channels of a content item. Large catalog of content items can be analyzed, and audio spatial complexity scores can be associated with various content items. If a user has a surround sound system, content items with a high audio spatial complexity can be retrieved or recommended to the user to demonstrate the surround sound system's value better.

### TECHNICAL FIELD

This disclosure relates generally to analyzing content items, and more specifically, to determining audio spatial complexity scores of content items.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates audio spatial complexity scoring to determine audio spatial complexity scores of content items, according to some embodiments of the disclosure.

FIG. 2 illustrates audio spatial complexity scoring to determine audio spatial complexity scores of content items, according to some embodiments of the disclosure.

FIG. 3 illustrates various algorithms for determining audio spatial complexity scores, according to some embodiments of the disclosure.

FIG. 4 illustrates a content item having exemplary audio spatial complexity scores, according to some embodiments of the disclosure.

FIG. 5 illustrates audio spatial complexity scoring based on metadata, according to some embodiments of the disclosure.

FIG. 6 illustrates audio spatial complexity scoring based on features using a model, according to some embodiments of the disclosure.

FIG. 7 illustrates a series of attention locations in a two-dimensional space, according to some embodiments of the disclosure.

FIG. 8 illustrates audio spatial complexity scoring based on audio attention locations analysis, according to some embodiments of the disclosure.

FIG. 9 illustrates audio spatial complexity scoring based on audio channels cross-correlation analysis, according to some embodiments of the disclosure.

FIG. 10 illustrates audio spatial complexity scoring based on audio object analysis, according to some embodiments of the disclosure.

FIG. 11 illustrates a content item having exemplary audio spatial complexity scores and visual complexity scores, according to some embodiments of the disclosure.

FIG. 12 is a block diagram of an exemplary computing device, according to some embodiments of the disclosure.

### DETAILED DESCRIPTION

### Overview

Surround sound systems can dramatically expand the size of a user's sound field. Some surround sound systems may have different speakers positioned at different, specific locations of a room. Surround sound content may include two or more audio channels which may correspond to the different speakers of the surround sound system. An audio channel includes an audio track or audio file having audio content, such as a sequence of audio samples over time. 5.1 surround sound may use five full-range channels (front left, center, front right, surround/rear left, surround/rear right) and one low-frequency channel (subwoofer). 7.1 surround sound may add two additional rear surround channels to the 5.1 setup for more precise audio positioning. 9.1 surround sound may further expand on 7.1 setup by adding two height channels for increased vertical sound dimensionality.

For some content items, surround sound content is mixed in a simplistic way where the front audio is copied to the rear, at a lower volume. It can be difficult for users to appreciate the value proposition of a surround sound system without more compelling spatially complex content and without knowing whether a content item would offer a good surround sound experience. Quantifying surround sound complexity of various content items based on an audio spatial complexity scoring system can address this issue.

Producing an audio spatial complexity score of audio content is not trivial and extends beyond signal similarity analysis techniques. Algorithms can be implemented to determine an audio spatial complexity score based on audio channels of and potentially other information associated with a content item. One or more of the algorithms take into account metadata about the content item. One or more of the algorithms utilizes a (trained) machine learning model to produce audio spatial complexity scores. One or more of the algorithms take into account that the audio spatial complexity scores may be different for different segments of a content item. The audio spatial complexity scores of different segments may be combined to form a full audio spatial complexity score of the content item. One or more of the algorithms take into account that the audio spatial complexity score can be conditioned on a visual complexity score of a content item. One or more of the algorithms take into account how characteristics of the audio channels evolve or move during the duration of the content item. Multiple algorithms can be combined to produce sub-scores, which may be combined together to form a composite audio spatial complexity score.

In some embodiments, the metadata associated with a content item, e.g., synopsis, genre, production credits, etc., can be used in determining or inferring an audio spatial complexity score of the content item. Metadata can serve as heuristics in quantifying the audio spatial complexity of a content item. Metadata can be used to boost audio spatial complexity scores, since the user experience is likely going to be influenced by other aspects of the content item in addition to the audio experience.

In some embodiments, a feature vector can be generated for a content item, e.g., based on audio channels, video content, and metadata associated with the content item, etc. The feature vector can be processed by a model to determine or infer an audio spatial complexity score of the content item. The model may include one or more machine learning models. Using a machine learning model can advantageously identify latent features in the content item that would be useful in determining the audio spatial complexity score.

In some embodiments, the attention locations over time can be determined based on audio channels of a content item. The attention locations can be used in determining or inferring an audio spatial complexity score of the content item. The audio channels can be reverse engineered to determine an audio source location by determining where the combined energy of the audio channels is the highest. The attention locations over time, representing the audio source locations over time, can be analyzed to assess one or more metrics, such as amount of movement, entropy and variance. Dynamic attention locations can suggest high audio spatial complexity. Conversely, static attention locations can suggest low audio spatial complexity.

In some embodiments, the cross-correlation between audio channels of a content item can be determined. The cross-correlation can be used in determining or inferring an audio spatial complexity score of the content item. Highly correlated audio channels can suggest that simplistic mixing was used to produce the audio channels. Uncorrelated audio channels can suggest that audio spatial complexity is high. A cross-correlation matrix can be used to determine cross-correlation across frequency and time-lag. Eigenvalue decomposition can be applied to the cross-correlation matrix to extract eigenvalues and eigenvectors to more robustly determine the audio spatial complexity score of a content item.

In some embodiments, a visual complexity score can be determined based on the video content of the content item. The visual complexity score can be used in determining or inferring an audio spatial complexity score of the content item. Because the user can experience the content item in a multi-sensory manner, the visual complexity score can be used to modulate the audio spatial complexity score.

In some embodiments, audio content is encoded using audio objects. The movement of the audio objects, and/or entropy of the locations of the audio objects can be used in determining or inferring an audio spatial complexity score of the content item.

Large catalog of content items can be analyzed, and audio spatial complexity scores can be associated with various content items. The audio spatial complexity can be used as a proxy for the surround sound experience. One or more algorithms can be applied at scale to thousands to millions of content items to produce audio complexity scores. The audio complexity scores can be associated with the content items in a content item data store.

If a user has a surround sound system, content items with a high audio spatial complexity can be retrieved or recommended to the user to demonstrate the surround sound system's value better. Without the audio spatial complexity scores, the surround sound experiences of different content items would be impossible to differentiate.

During content item production, the audio mixing engineer can utilize the audio spatial complexity score as a proxy for the surround sound experience. The audio spatial complexity score can be used by the audio mixing engineer as feedback information to help fine tune or select algorithms to use when mixing and producing the audio channels of the content item.

### Utilizing Audio Spatial Complexity Scores in a Digital Content Platform and a Content Production Platform

A digital content platform may allow users to access and view thousands to millions of content items. Content items may include media content, such as audio content, video content, image content, augmented reality content, virtual reality content, mixed reality content, game, textual content, interactive content, etc. Examples of content items may include books, audio books, music, movies, television series, mini-series, advertisements, short films, films, documentaries, podcasts, audio clips, radio programming, games, interactive content, immersive content, etc.

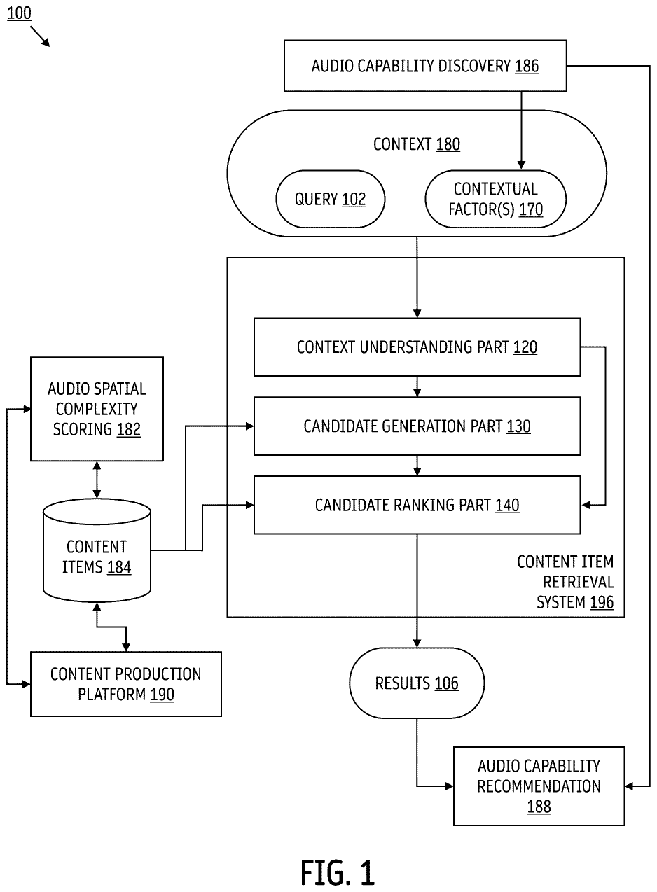

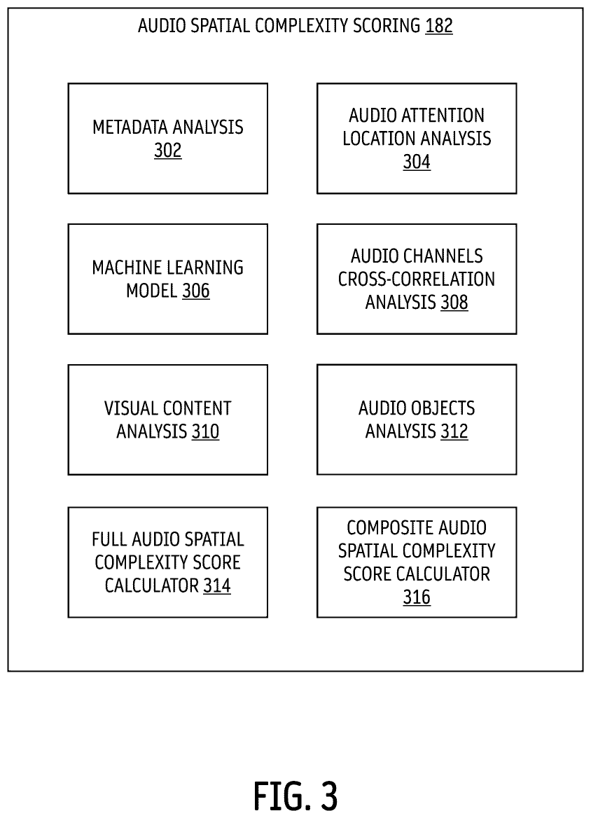

FIG. 1 illustrates audio spatial complexity scoring to determine audio spatial complexity scores of content items, according to some embodiments of the disclosure. FIG. 1 depicts system 100 having audio spatial complexity scoring 182. Audio spatial complexity scoring 182 may use information associated with content items 184 (stored in a content items data store) to determine audio spatial complexity scores and associate the audio spatial complexity scores with content items 184. Details relating to audio spatial complexity scoring 182 are described with FIGS. 3-11.

Users may routinely interact with a digital content platform by performing searches using the content item retrieval system. A search may begin with a query (e.g., query 102), and results 106 may be generated and output to the user.

Context 180 may be provided as input to content item retrieval system 196. Content item retrieval system 196 may include several operations. Content item retrieval system 196 may include one or more of: context understanding part 120, candidate generation part 130, and candidate ranking part 140. Content item retrieval system 196 may generate results 106.

Context 180 may capture context of a particular search session with a user. Context 180 may capture information that may be helpful for understanding what a user is looking for and/or what may be relevant or useful to the user. In some cases, context 180 may include query 102.

Query 102 may include natural language text and/or description provided by a user. Query 102 may include a natural language query. In some cases, query 102 may include a user-provided voice-based or text-based query to find content items. Examples of query 102 may include:
“Show me funny office comedies with romance”
“TV series with strong female characters”
“I want to watch 1980s romantic movies with a happy ending”
“Short animated film that talks about family values”
“Are there blockbuster movies from 1990s that involves a tragedy?”
“What is that movie where there is a Samoan warrior and a girl going on a sea adventure?
“What are some most critically-acclaimed dramas right now?”
“I want to see a film set in Tuscany but is not dubbed in English”
“Recommend me movies of Brad Pitt that are free for me to watch”
“I want something that will fully utilize the expensive sound system I just installed!”
“Show me some movies that has immersive surround sound”

In some cases, context 180 may include query 102 and optionally one or more contextual factors 170. Examples of contextual factors 170 can include: characteristic(s) about the user making the query, time of day, day of the week, time of the year, seasonality (e.g., seasons, special events, holidays, etc.), one or more past queries made by the user, one or more past user interactivity information with the content platform (e.g., what the user clicked on, what the user has watched, etc.), whether the query is voice-based or text-based, the type of device that the user is using (e.g., mobile device versus television), the type of application that the user is using, whether the user is a paid subscriber or not, what subscriptions the user has, demographics about the user, whether the user is an expert/experienced user or not, whether the user is a loyal user or not, how many retrieved content items the user is looking for, characteristic(s) about the device the user is using to input the natural language query, the amount of bandwidth the user has on a network to receive content, the user's position in a social graph/network, the user's relationships with other users in a social graph/network, etc.

In some embodiments, audio capability discovery 186 may be included to determine or discover one or more audio capabilities of a system being used by the user to consume content items. In one example, audio capability discovery 186 may query a capability manifest of the system to determine whether surround sound or a specific type of surround sound is supported. In one example, audio capability discovery 186 may query a device communicably connected to the system to retrieve a device identifier or model and/or device capability. Based on the device identifier or model and/or device capability, audio capability discovery 186 can determine whether surround sound or a specific type of surround sound is supported. The device may be communicably connected to the system via interfaces such as High-Definition Multimedia Interface (HDMI), DisplayPort, Universal Serial Bus (USB), optical audio link (e.g., S/PDIF), Bluetooth, or a wireless network. For a device connected to the system via HDMI, audio capability discovery 186 may receive information from the device (e.g., a device identifier or model and/or device capability) via the Audio Return Channel (ARC) or Enhanced Audio Return Channel (eARC). For a device connected to the system via HDMI, the information may include Extended Display Identification Data (EDID) that communicates one or more audio capabilities of the device to the system. In some embodiments, audio capability discovery 186 may determine whether the surround sound capability or a type of surround sound is turned on or enabled. The one or more audio capabilities of the system being used by the user can be included as a part of one or more contextual factors 170.

Context 180 may be provided as input to context understanding part 120. Context understanding part 120 may process context 180 to understand context 180, e.g., to extract contextual cues, semantic meaning, user intent, etc. In some cases, context understanding part 120 may implement a large language model. A prompt may be generated based on context 180, and the prompt may be used as input to the large language model. Context understanding part 120 may process context 180 (e.g., receive a prompt that has information about context 180 and an instruction having questions about context 180) and extract one or more attributes or other suitable information about context 180.

Based on information from context understanding part 120, candidate generation part 130 may search in content items 184 to determine relevant candidates to context 180. The one or more extracted attributes or other suitable information from context understanding part 120 may be provided to candidate generation part 130 to find semantically and/or contextually relevant candidates, e.g., content items in content items 184 that are semantically and/or contextually relevant to context 180. Candidate generation part 130 may find candidates in content items 184 that are semantically and/or contextually relevant to context 180. Candidate generation part 130 may use one or more models to identify a set of relevant candidates, e.g., content items relevant to context 180. Examples of models may include keyword matching, vector space model, probabilistic model, etc. One or more models may be used to score the candidates in content items 184 and determine relevance scores. Top K highest relevance scoring candidates may be returned as the set of relevant candidates. Relevant candidates may be provided to candidate ranking part 140 for ranking.

In some embodiments, audio spatial complexity scores determined by audio spatial complexity scoring 182 may impact operations in candidate generation part 130. For example, audio spatial complexity scores may be used by candidate generation part 130 to determine relevance scores of the candidates. Audio spatial complexity scores may be a component of the relevance score determined by candidate generation part 130. Content items with high audio spatial complexity scores may be scored higher by candidate generation part 130. In another example, content items with high audio spatial complexity scores may be scored higher by candidate generation part 130 if context 180 (e.g., the one or more contextual factor(s) 170) indicates that the system has surround sound capability or supports a sophisticated surround sound capability. In another example, content items with high audio spatial complexity scores may be scored higher by candidate generation part 130 if context 180 indicates a user's intent to seek content with high audio spatial complexity scores, or if context 180 suggests that the user would appreciate be well matched with content with high audio spatial complexity scores. In another example, audio spatial complexity scores may be part of feature embeddings representing content items 184, and candidate generation part 130 may generate relevant scores for candidates using the feature embeddings. In another example, candidate generation part 130 may enforce a rule to include a predetermined number or proportion of relevant candidates in the top K highest relevance scoring candidates that have an audio spatial complexity score over a threshold. In another example, candidate generation part 130 may use the audio spatial complexity scores to create cohorts of content items having the same or similar audio complexity scores and enforce a rule to include a predetermined number of relevant candidates from each cohort.

Candidate ranking part 140 may rank the set of relevant candidates produced by candidate generation part 130. Candidate ranking part 140 may determine and output ranked candidates. Candidate ranking part 140 may determine a ranking score for each relevant candidate found by candidate generation part 130 and sort the relevant candidates based on the ranking scores to produce ranked relevant candidates. In some cases, candidate ranking part 140 may rank content items based on information from context understanding part 120. The one or more extracted attributes or other suitable information from context understanding part 120 may be provided to candidate ranking part 140 to augment ranking of relevant candidates, e.g., content items relevant to context 180.

In some embodiments, audio spatial complexity scores determined by audio spatial complexity scoring 182 may impact operations in candidate ranking part 140. For example, audio spatial complexity scores may be used by candidate ranking part 140 to determine ranking scores of the candidates. Audio spatial complexity scores may be a component of the ranking score determined by candidate ranking part 140. Content items with high audio spatial complexity scores may be scored higher or ranked higher by candidate ranking part 140. In another example, candidate ranking part 140 may enforce a rule to place relevant candidates that have an audio spatial complexity score over a threshold in top N positions in the ranking. In another example, candidate ranking part 140 may signal one or more relevant candidates whose audio spatial complexity scores are over a threshold. In another example, audio spatial complexity scores may be used by candidate ranking part 140 to boost ranking scores of the relevant candidates. In some scenarios, relevant candidates with audio spatial complexity scores above a threshold may be ranked lower depending on context 180 (e.g., if context 180 indicates that the system does not have surround sound capability). However, it may be beneficial to rank the relevant candidates with high audio spatial complexity scores higher or place the relevant candidates in a higher position to encourage safe exploration and exposure to the relevant candidates with audio spatial complexity scores above a threshold. Candidate ranking part 140 may rank the relevant candidates based on a weighted sum of ranking scores and audio spatial complexity scores. Candidate ranking part 140 may enforce a rule to ensure that at least the relevant candidate having a highest audio spatial complexity score is in one of the top N positions in the ranking. In some cases, candidate ranking part 140 may decide randomly whether to boost ranking scores of relevant candidates based on the audio spatial complexity scores.

Content item retrieval system 196 may return results 106 having ranked relevant candidates, e.g., content items relevant to context 180. Results 106 may be returned to the user who provided or input query 102. Results 106 may be output (e.g., rendered for display) to the user. Results 106 may be output to the user according to the ranking determined in candidate ranking part 140. In some cases, results 106 may be accentuated (e.g., enlarged) based on signaling from candidate ranking part 140.

In some cases, a portion of results 106 having one or more content items relevant to context 180 may be displayed to the user as a separate row or category with a label, e.g., “surround sound highlight channel”, “in your face surround sound”, or “surround sound spotlight”, based on the signaling from candidate ranking part 140 indicating that the audio spatial complexity score of the content item is above a threshold.

In some cases, audio capability recommendation 188 may determine, based on results 106, a recommendation to the user to purchase or upgrade an audio output device. In some cases, audio capability recommendation 188 may determine, based on results 106, a recommendation to the user to turn on or enable the surround system capability. Audio capability recommendation 188 may make the determination based on the proportion of content items in results 106 that has high audio spatial complexity scores (e.g., audio spatial complexity scores above a threshold), and the one or more audio capabilities discovered by audio capability discovery 186.

### Content Item Recommendation Systems

In some cases, one or more content items may be recommended to a user without involving a search. One or more content items may be recommended to a user when a user is using the digital content platform. One or more content items may be recommended to a user while the user is watching a content item. One or more content items may be recommended to a user when the user has just finished watching a content item. One or more content items may be recommended to a user when the user has interacted with a content item (e.g., liked, disliked, added to favorites, added to a watch later list, etc.).

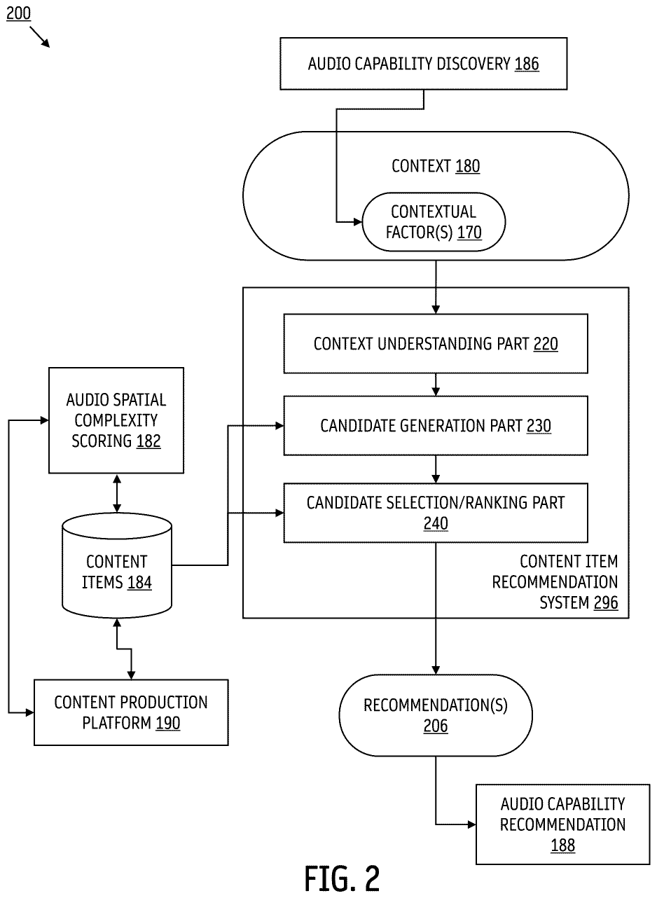

FIG. 2 illustrates audio spatial complexity scoring to determine audio spatial complexity scores of content items, according to some embodiments of the disclosure. FIG. 2 depicts system 200 having audio spatial complexity scoring 182. Users may routinely interact with content items recommended by a digital content platform. One or more recommendations 206 may be generated based on context 180. One or more recommendations 206 may be output to the user.

Context 180 may be provided as input to content item recommendation system 296. Content item recommendation system 296 may include several operations. Content item recommendation system 296 may include one or more of: context understanding part 220, candidate generation part 230, and candidate selection/ranking part 240. Content item recommendation system 296 may generate recommendations 206.

Context 180 may capture context of a particular session with a user. Context 180 may capture information that may be helpful for understanding the current context of the user and/or what may be relevant or useful to the user. Context 180 may include one or more contextual factors 170.

Context 180 may be provided as input to context understanding part 220. Context understanding part 120 may process context 180 to understand context 180, e.g., to extract contextual cues, user intent, etc. Context understanding part 220 may process one or more contextual factors 170 and extract one or more attributes or other suitable information about context 180.

Candidate generation part 230 may be implemented similarly to candidate generation part 130 of FIG. 1. In some embodiments, audio spatial complexity scores determined by audio spatial complexity scoring 182 may impact operations in candidate generation part 230 in one or more manners similar to how audio spatial complexity scores impact operations in candidate generation part 130.

Candidate selection/ranking part 240 may be implemented similarly to candidate ranking part 140 of FIG. 1. In practice, content item recommendation system 296 may produce one or more recommendations 206 (e.g., just one or two content items), whereas content item retrieval system 196 of FIG. 1 may produce several results 106 (e.g., a dozen content items). Candidate selection/ranking part 240 may be more selective when producing one or more recommendations 206 than candidate ranking part 140. Candidate selection/ranking part 240 may trim or filter out relevant candidates that do not meet one or more criteria.

In some embodiments, audio spatial complexity scores determined by audio spatial complexity scoring 182 may impact operations in candidate selection/ranking part 240 in one or more manners similar to how audio spatial complexity scores impact operations in candidate selection/ranking part 140. In one example, candidate selection/ranking part 240 may enforce a rule to return a relevant candidate that has the highest audio spatial complexity score. In another example, candidate selection/ranking part 240 may enforce a rule to return two relevant candidates that have the highest audio spatial complexity scores.

Content item recommendation system 296 may return one or more recommendations 206 having (ranked) relevant candidates, e.g., recommended content items relevant to context 180. One or more recommendations 206 may be returned to the user. One or more recommendations 206 may be output (e.g., rendered for display) to the user. One or more recommendations 206 may be output to the user according to the selection/ranking determined in candidate selection/ranking part 240. In some cases, one or more recommendations 206 may be accentuated (e.g., enlarged) based on signaling from in candidate selection/ranking part 240 indicating that the audio spatial complexity score of the content item is above a threshold.

In some cases, audio capability recommendation 188 may determine, based on one or more recommendations 206, a recommendation to the user to purchase or upgrade an audio output device. In some cases, audio capability recommendation 188 may determine, based on one or more recommendations 206, a recommendation to the user to turn on or enable the surround system capability. Audio capability recommendation 188 may make the determination based on one or more recommendations 206 having one or more audio spatial complexity scores above a threshold, and the one or more audio capabilities discovered by audio capability discovery 186.

Referring to both FIG. 1 and FIG. 2, audio spatial complexity scoring 182 may be used with content production platform 190. During content item production or creation, a content engineer or creator can utilize the audio spatial complexity score determined for a particular content item being produced or created using content production platform 190 as a proxy for the surround sound experience. Content production platform 190 may provide the content item to audio spatial complexity scoring 182 and receive one or more audio spatial complexity scores associated with the content item or segments of the content item from audio spatial complexity scoring 182. The audio spatial complexity score can be output to the engineer or creator as feedback information to help the engineer or creator fine tune or select algorithms to use when mixing and producing the audio channels of the content item. The audio spatial complexity score can encourage more interesting content items to be produced and created. Without the score, it would be more challenging for the engineer or creator to quantify or measure the surround sound experience.

### Algorithms for Determining Audio Spatial Complexity Scores

FIG. 3 illustrates various algorithms for determining audio spatial complexity scores, according to some embodiments of the disclosure. Audio spatial complexity scoring 182 may include one or more of: metadata analysis 302, audio attention location analysis 304, model 306, audio channels cross-correlation analysis 308, visual content analysis 310, and audio objects analysis 312. Audio spatial complexity scoring 182 may include full audio spatial complexity score calculator 314. Audio spatial complexity scoring 182 may include composite audio spatial complexity score calculator 316.

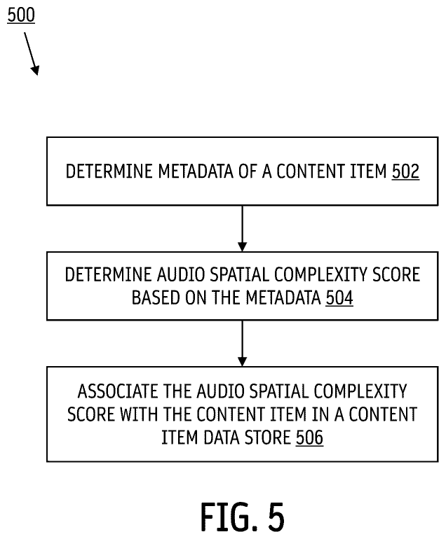

Metadata analysis 302 may determine an audio spatial complexity score based on metadata associated with a content item. Examples of metadata may include: such as plot line, synopsis, director, list of actors, list of artists, list of writers, list of characters, length of content item, language of content item, country of origin of content item, genre, category, tags, viewers'ratings, critic's ratings, parental ratings, production company, release date, release year, platform on which the content item is released, whether it is part of a franchise or series, type of content item, viewership, popularity score, audio channel information (e.g., number of audio channels, format of the audio, etc.), availability of subtitles, beats per minute, list of filming locations, list of awards, list of award nominations, seasonality information, etc. Metadata analysis 302 may infer from the metadata when quantifying audio spatial complexity of a content item. For instance, the genre of the content item may indicate whether the content item is likely to have high audio spatial complexity. Reality television may suggest that the content item is unlikely to have high audio spatial complexity, whereas blockbuster sci-fi movies may suggest that the content item is likely to have high audio spatial complexity. In another instance, audio channel information may suggest that the content item was mixed with the intent to offer a good surround sound experience. A high number of audio channels (e.g., 6 or more audio channels) may suggest that the content item is likely to have high audio spatial complexity. An audio format that is object-based to support an arbitrary number of speakers may suggest that the content item is likely to have high audio spatial complexity. In some cases, metadata analysis 302 may extract, from the metadata, one or more factors used in calculating audio spatial complexity scores. For instance, metadata can serve as an indicator for the overall user experience that a user is likely going to experience or other aspects of the user experience that would complement the surround sound audio experience. In one example, the metadata may suggest that the content item is created by a production studio that is known to produce high quality surround sound experiences. In another example, the metadata may suggest that the content item is available at a high video resolution with the intent to be consumed by users with home theater equipment. Some metadata may be used by metadata analysis 302 as one or more factors that can increase an audio spatial complexity score being determined by one or more components in audio spatial complexity scoring 182, if the metadata suggests that the user experience is likely going to be positively influenced by other aspects of the content item in addition to the audio experience. Exemplary methods performed by metadata analysis 302 are illustrated in FIG. 5.

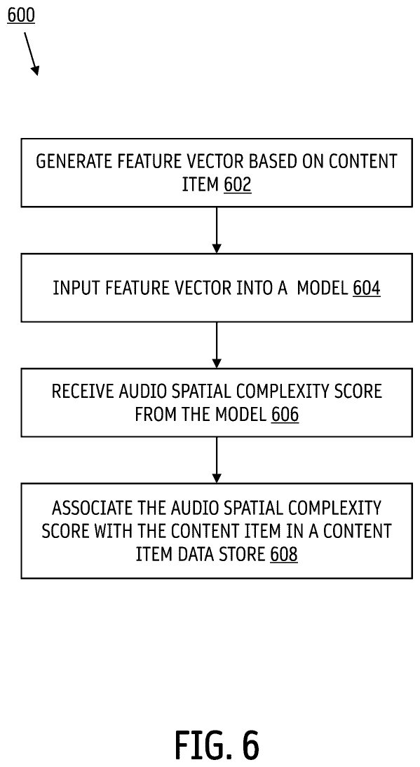

Model 306 may determine an audio spatial complexity score based on a feature vector generated for a content item. Model 306 may include a feature extraction part (having e.g., a machine learning model, a neural network, a convolutional neural network, a statistical model, frequency transform, etc.) that receives input data associated with the content item and produces the feature vector for the content item. The feature vector may include a vector of values. The input data may include one or more of: one or more audio channels, video content, one or more video frames, and metadata associated with the content item, etc. The feature vector can be processed by an inference part of model 306 to determine or infer an audio spatial complexity score of the content item. The inference part may include a machine learning model. A machine learning model in model 306 may be trained using training data produced by human users annotating content items with audio spatial complexity scores. The training data can be used to train one or more of the feature extraction part and the inference part of model 306. Examples of the inference part of model 306 may include logistic regression model, linear regression model, decision trees, random forest, gradient boosting machine, support vector machine, neural network, naïve Bayes, K-nearest neighbors, etc. Exemplary methods performed by model 306 are illustrated in FIG. 6.

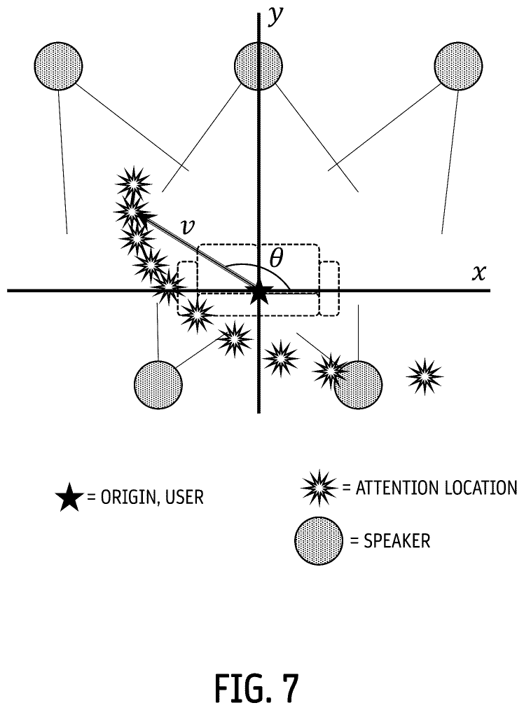

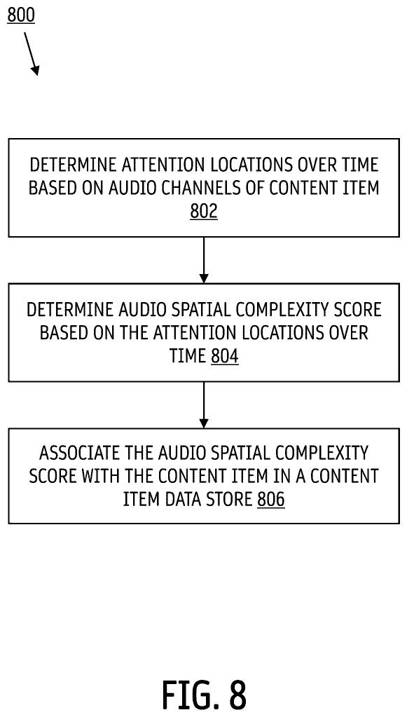

Audio attention location analysis 304 can determine a plurality of attention locations over time or across the duration of a content item or a segment of a content item based on audio channels of a content item. The attention locations, in particular, how the attention locations evolve or change over time or across the duration of a content item or a segment of a content item indicate audio spatial complexity of the content item. An attention location can be defined based on coordinates within a two-dimensional space, such as top view over a living room and an origin located at where a user may be located. An attention location can be defined within coordinates within a three-dimensional space, such a living room and an origin located at where a user may be located. An attention location can be defined based on a vector, such as unit vector with a magnitude of one, or a vector with a specific magnitude. A vector may have a direction, an angle, or a direction angle of the vector within the space. One insight is that movement and diverse attention locations suggests higher audio spatial complexity. Another insight is that the audio channels can be reverse engineered to determine an audio source location by determining where the combined energy of the audio channels is the highest. Also, the audio channels can be reverse engineered to determine a unit vector to an audio source location and an angle of the vector by determining the direction towards the location where the combined energy of the audio channels is the highest. Exemplary methods performed by audio attention location analysis 304 are illustrated in FIGS. 7-8.

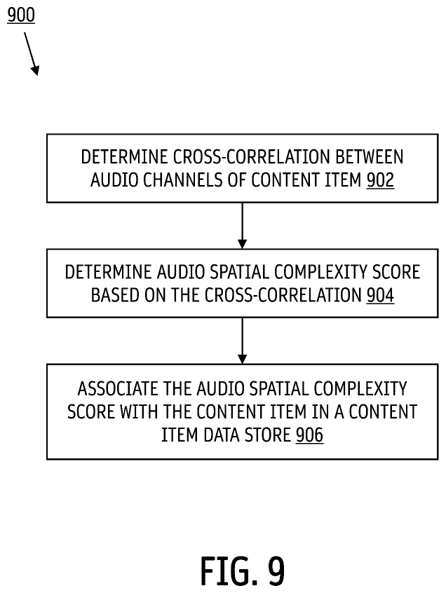

Audio channels cross-correlation analysis 308 can determine pairwise cross-correlation between audio channels of a content item. One or more pairwise cross-correlations can be used by audio channels cross-correlation analysis 308 in determining or inferring an audio spatial complexity score of the content item. Highly correlated audio channels can suggest that simplistic mixing was used to produce the audio channels. Uncorrelated audio channels can suggest that audio spatial complexity is high. The cross-correlation of two audio channels is a result of sliding one audio channel over the other and calculating their similarity at each position and can measure how well the two audio channels match up at different time offsets. When a rear audio channel is a lower volume copy of a front audio channel, the cross-correlation of the audio channels is very high at a zero-delay time-lag. The cross-correlation can be used by audio channels cross-correlation analysis 308 identify content items that were mixed simplistically and lack audio spatial complexity and assign low audio spatial complexity scores to those content items. Audio channels cross-correlation can be performed by audio channels cross-correlation analysis 308 using time-domain audio samples of two audio channels. Cross-correlation can be performed by audio channels cross-correlation analysis 308 using short-time frequency transform information (e.g., Short-Time Fourier Transform or STFT) of two audio channels. STFT can divide a longer time audio channel into shorter segments of (equal) length and then may compute the Fourier transform separately on each segment. In some cases, STFT can create overlapping segments using a sliding window and may compute Fourier transform separately on each overlapping segment. STFT allows for the analysis of frequency content of an audio channel as it evolves over time. STFT can produce a spectrogram that illustrates frequency versus time. In some implementations, a cross-correlation matrix can be calculated by audio channels cross-correlation analysis 308 for a pair of audio channels to assess cross-correlation of the audio channels across frequency and time-lag. Audio channels cross-correlation analysis 308 can apply eigenvalue decomposition of the cross-correlation matrix to extract eigenvalues and eigenvectors to determine the audio spatial complexity score of a content item. Applying eigenvalue decomposition allows patterns across multiple frequencies to be considered and can also extract spatial patterns and/or locations of source sources in the audio channels. Audio channels cross-correlation analysis 308 can produce different cross-correlation matrices for multiple segments of the content item to examine the changes in eigenvalues and/or eigenvectors to determine the audio spatial complexity score of a content item. Exemplary methods performed by audio channels cross-correlation analysis 308 are illustrated in FIG. 9.

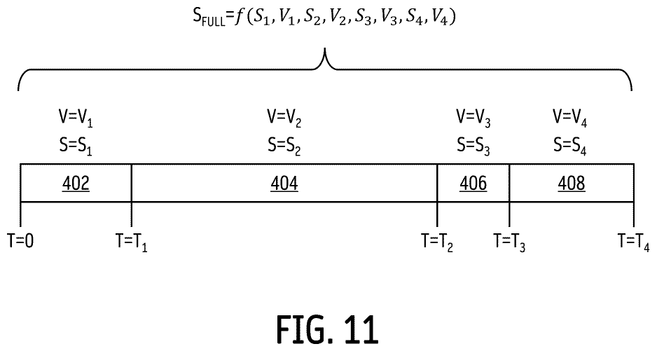

Visual content analysis 310 may determine a visual complexity score based on the video content of the content item. In some cases, a visual complexity score may be determined based on subtitles describing a scene in the content item. In some cases, a visual complexity score may be determined based on motion fields of the video frames, where a motion field of a video frame has motion vectors of the video frame measuring movement between video frames. In some cases, a visual complexity score may be determined based on object motion information of the video frames, where object motion information may include information describing how objects are moving between video frames. In some cases, a visual complexity score may be determined based on object motion information of the video frames, where object motion information may include a number of foreground objects with high motion vectors. In some cases, a visual complexity score may be determined using a model, such as a convolutional neural network. Visual content analysis 310 may determine or infer an audio spatial complexity score of the content item based in part on the visual complexity score. Because the user can experience the content item in a multi-sensory manner, the visual complexity score can be used to modulate the audio spatial complexity score or be used as a factor in determining the audio spatial complexity score. For instance, a high audio spatial complexity score is determined when one or more components of audio spatial complexity scoring 182 determines there is high audio spatial complexity and visual content analysis 310 determines there is high visual complexity. In another instance, an audio spatial complexity score is determined only when visual content analysis 310 determines there is high visual complexity. An insight is that audio spatial complexity may only matter or be important when there is high visual complexity. An example of how a visual complexity score may affect an audio spatial complexity score is illustrated in FIG. 11.

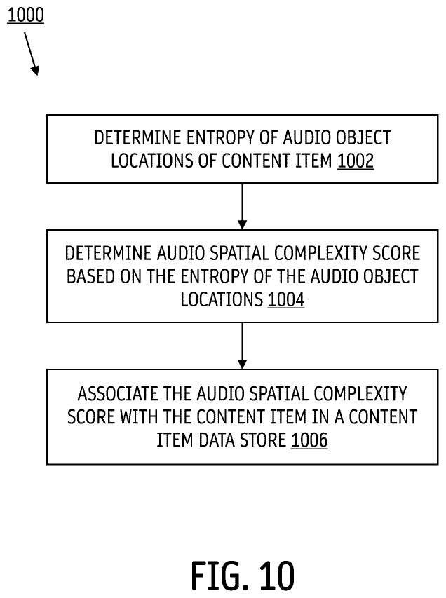

Audio objects analysis 312 may extract spatial complexity information from audio content of a content item that is encoded using audio objects. Audio object encoded audio content may break down an audio scene into individual audio objects with its own audio content and metadata. In particular, the metadata of an audio object may include one or more properties such as position, size, and movement in space. At a receiver, the audio objects are decoded and rendered to different speakers based on the metadata of the audio objects. Audio objects analysis 312 can extract from the metadata information about the audio objects, such as position, movement, path or trajectory of audio objects, variation or variance in the movement or position, frequency components of the movement or position, entropy of the movement or position, to determine an audio spatial complexity score of the content item. Audio objects analysis 312 may determine an audio spatial complexity score based on the metadata of audio objects, or a suitable derivation thereof. For instance, an audio object of the content item that has high variance for the position of the audio object may suggest that the content item has high audio spatial complexity. In another instance, an audio object of the content item that has high entropy for the position of the audio object may suggest that the content item has high audio spatial complexity. In another instance, an audio object of the content item that traverses or moves from the front to the rear of the audio space or vice versa a number of times above a threshold may suggest that the content item has high audio spatial complexity. Exemplary methods performed by audio objects analysis 312 are illustrated in FIG. 10.

Full audio spatial complexity score calculator 314 may determine a full audio spatial complexity score for a content item and associate the full audio spatial complexity score to the content item. The full audio spatial complexity score may be determined based on audio spatial complexity scores associated with segments of a content item. One insight is that the audio spatial complexity scores for different parts of a content item are likely to be different over the duration of the content item. A content item that has a subset of segments that have high audio complexity scores may still have a high full audio spatial complexity score. In some cases, a content item may be segmented into segments of equal lengths, e.g., non-overlapping segments, or overlapping segments. In some cases, a content item may be segmented into segments of different lengths based on scene change boundaries. Audio spatial complexity scores may be determined individually or separately for the segments of the content item. Audio spatial complexity scores for the segments may be associated with the segments of the content item in the content data store to tag or mark segments of content item with high audio spatial complexity scores. Full audio spatial complexity score calculator 314 may aggregate or combine the audio spatial complexity scores for the segments to determine the full audio spatial complexity score. In some embodiments, full audio spatial complexity score calculator 314 may determine the full audio spatial complexity score by calculating an average of the audio spatial complexity scores for the segments. Full audio spatial complexity score calculator 314 may further determine whether the average is above a threshold. In some embodiments, full audio spatial complexity score calculator 314 may determine the full audio spatial complexity score by calculating a weighted average of the audio spatial complexity scores for the segments where the weights are inversely related to the length or duration of the segment. Full audio spatial complexity score calculator 314 may further determine whether the weighted average is above a threshold. In some embodiments, full audio spatial complexity score calculator 314 may determine the full audio spatial complexity score by examining a histogram of audio spatial complexity scores for the segments to assess whether the histogram is skewed towards high scores. If the histogram is skewed towards high scores, full audio spatial complexity score calculator 314 may set a high full audio spatial complexity score. If the histogram is skewed towards low scores, full audio spatial complexity score calculator 314 may set a low full audio spatial complexity score. In some embodiments, full audio spatial complexity score calculator 314 may determine the full audio spatial complexity score by examining a plot of audio spatial complexity scores for the segments across the duration of the content item to assess whether the plot has a number of peaks. If the number of peaks is above a threshold, full audio spatial complexity score calculator 314 may set a high full audio spatial complexity score. If the number of peaks is below a threshold, full audio spatial complexity score calculator 314 may set a low full audio spatial complexity score. In some embodiments, full audio spatial complexity score calculator 314 may determine the full audio spatial complexity score by determining a proportion of audio spatial complexity scores for the segments that are above a threshold. If the proportion is above a threshold, full audio spatial complexity score calculator 314 may set a high full audio spatial complexity score. If the proportion is below a threshold, full audio spatial complexity score calculator 314 may set a low full audio spatial complexity score.

Composite audio spatial complexity score calculator 316 may determine a composite audio spatial complexity score for a content item or a segment of the content item and associate the composite audio spatial complexity score to the content item or the segment of the content item. As illustrated by the components depicted in FIG. 3 for audio spatial complexity scoring 182, an audio spatial complexity score may be determined using different algorithms. In some embodiments, a composite audio spatial complexity score may be calculated by composite audio spatial complexity score calculator 316 using an ensemble or selection of audio spatial complexity scores determined using different algorithms. For example, composite audio spatial complexity score calculator 316 may calculate a composite audio spatial complexity score based on an average or a weighted average of audio spatial complexity scores determined using different algorithms. In another example, composite audio spatial complexity score calculator 316 may determine a composite audio spatial complexity score by applying a logic tree to audio spatial complexity scores determined using different algorithms. In another example, composite audio spatial complexity score calculator 316 may determine a composite audio spatial complexity score by applying a model to audio spatial complexity scores determined using different algorithms. Using an ensemble or selection of audio spatial complexity scores may advantageously make audio spatial complexity scoring 182 more robust to potential false positives or errors of the individual algorithms.

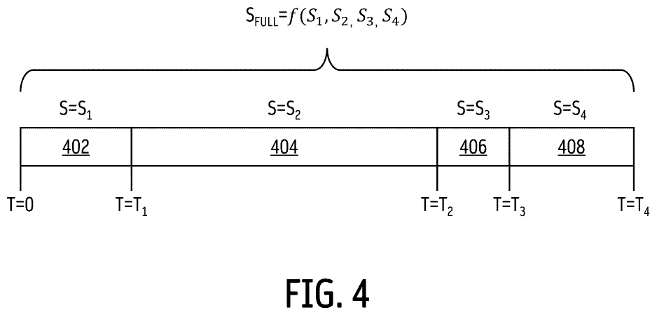

FIG. 4 illustrates a content item having exemplary audio spatial complexity scores, according to some embodiments of the disclosure. The illustrative content item has four segments, e.g., segment 402, segment 404, segment 406, and segment 408. As depicted, segments may have different lengths or duration, but it is envisioned by the disclosure that the segments may be of equal lengths or durations. Audio spatial complexity scoring 182 of FIG. 3 may apply one or more algorithms to determine an audio spatial complexity score S₁ of segment 402 and associate the audio spatial complexity score S₁ to segment 402 in a content item data store. Audio spatial complexity scoring 182 may apply one or more algorithms to determine an audio spatial complexity score S₂ of segment 404 and associate the audio spatial complexity score S₂ to segment 404 in the content item data store. Audio spatial complexity scoring 182 may apply one or more algorithms to determine an audio spatial complexity score S₃ of segment 406 and associate the audio spatial complexity score S₃ to segment 406 in the content item data store. Audio spatial complexity scoring 182 may apply one or more algorithms to determine an audio spatial complexity score S₄ of segment 408 and associate the audio spatial complexity score S₄ to segment 408 in the content item data store. In some embodiments, the audio spatial complexity scores of the segments, S₁, S₂, S₃, and S₄, may be composite audio spatial complexity scores calculated by composite audio spatial complexity score calculator 316 of FIG. 3. In some embodiments, full audio spatial complexity score calculator 314 of FIG. 3 may determine a full audio spatial complexity score SFULL based on or as a function of the audio spatial complexity scores of the segments, S₁, S₂, S₃, and S₄.

FIG. 5 illustrates audio spatial complexity scoring based on metadata, according to some embodiments of the disclosure. FIG. 5 illustrates method 500. In 502, metadata of a content item is determined. In 504, an audio spatial complexity score of the content item may be determined based on the metadata. In 506, the audio spatial complexity score may be associated with the content item in a content item datastore.

FIG. 6 illustrates audio spatial complexity scoring based on features using a model, according to some embodiments of the disclosure. FIG. 6 illustrates method 600. In 602, a feature vector can be generated based on a content item. In 604, a feature vector may be input into a model. In 606, an audio spatial complexity score may be received from the model. In 608, the audio spatial complexity score may be associated with the content item in a content item datastore.

FIG. 7 illustrates a series of attention locations in a two-dimensional space, according to some embodiments of the disclosure. One insight is that the audio channels or the audio content of the content item can be analyzed to determine the series of attention locations in space. The series of attention locations over time or across a duration of a content item can reveal information about the audio spatial complexity of a content item. For simplicity, two-dimensional space is depicted in FIG. 7, but it is envisioned by the disclosure that attention locations can be determined in a three-dimensional space as well.

The two-dimensional space depicted represents a top view of a room occupied by a user having a 5-speaker setup (front left, front center, front right, rear left, and rear right). The user may be at the origin of the two-dimensional space. In some cases, the two-dimensional space may be represented by a grid of cells.

An attention location can be represented by two-dimensional coordinates in the two-dimensional space. An attention location can be represented by a vector (e.g., a unit vector or a vector of arbitrary magnitude v) pointing from the origin towards the attention location, and a direction angle θ of the vector. An attention location can be represented by a specific cell in the grid that represents the two-dimensional space in which the attention location is located. A cell may have coordinates within the grid. An attention location may have one or more properties, such as coordinates in space, vector, direction angle, a specific cell of a grid, etc.

As shown in the example, the attention locations extracted from the audio channels or the audio content of the content item may move within the two-dimensional space. One or more properties of the attention locations over time or across the duration of the content item can be analyzed to determine an audio spatial complexity score. In some cases, movement/path/trajectory of the one or more properties can be analyzed to determine an audio spatial complexity score. In some cases, entropy and/or variance of the one or more properties can be analyzed to determine an audio spatial complexity score. The number of crossings of the series of attention locations of the x-axis (or a number of threshold crossing of a coordinate or a line/plane in the space) can be determined and used to determine an audio spatial complexity score. In some cases, the attention locations or one or more properties of the attention locations may be low-pass filtered or bandpass filtered to remove noise or jitter in the data.

FIG. 8 illustrates audio spatial complexity scoring based on audio attention locations analysis, according to some embodiments of the disclosure. FIG. 8 illustrates method 800. In 802, attention locations over time may be determined based on audio channels of a content item. In 804, audio spatial complexity score of the content item may be determined based on the attention locations. In 806, the audio spatial complexity score of the content item may be associated with the content item in a content item data store.

In some embodiments, the attention locations over time are determined using a grid having cells in a space. The space may be a two-dimensional space having a grid of cells. In some cases, the space may be a three-dimensional space having voxels as cells. For a particular cell in the grid, or each cell in the grid, a combined energy of the audio channels at the particular cell at a particular time can be determined using the audio channels. The cell having a highest combined energy among the cells of the grid can be set as an attention location for the particular time. There may be multiple cells with highest combined energy for the particular time, and multiple cells may be set as multiple attention locations for the particular time. Determining the combined energy of the audio channels at the particular cell or determining an attention location can involve one or more metrics relating to intensity or energy of an audio signal in an audio channel. An energy of the audio channel may include an ensemble or selection of metrics relating to the intensity or energy of the audio signal of the audio channel. One example may include root mean squared (RMS) measurement of an audio channel to represent the energy of the audio channel. One example may include applying envelope amplitude detection to determine the intensity or amplitude measurement of an audio channel to represent the energy of the audio channel. One example may include loudness units full scale (LUFS) measurement of an audio channel to represent the energy of the audio channel. One example may include decibels relative to full scale (dBFS) measurement of an audio channel to represent the energy of the audio channel. In some embodiments, the energy calculation takes into account of decay over a distance between a source location of the audio channel (e.g., location of the speaker in the room) to a center point of a cell (e.g., the cell for which the combined energy is being calculated).

In some cases, the attention locations over time can be determined by transforming a vector of intensity or energy values of audio channels using a transformation matrix to derive a vector of an attention location within the space. The transformation matrix may translate, rotate, or project the intensity or energy values of the audio channels into a vector and (optionally) a direction angle for the vector within coordinate system having an origin located at the expected location of the user (e.g., as illustrated in FIG. 7). The transformation matrix may be predefined based on a typical speaker setup of the room.

In some embodiments, determining the audio spatial complexity score may include determining an entropy of the attention location, e.g., an entropy of a property of the attention location. The audio spatial complexity score may be determined based on the entropy. In some embodiments, determining the audio spatial complexity score may include determining a variance of the attention location, e.g., a variance of a property of the attention location. The audio spatial complexity score may be determined based on the variance. In some embodiments, determining the audio spatial complexity score may include determining coordinates of the series of attention locations along a first dimension or an axis in the space. The audio spatial complexity score may be determined based on a number of threshold crossings of the coordinates along the first dimension, or a number of axis/plane/line crossings of the coordinates. Count of threshold crossings and axis/plane/line crossings can measure and quantify diverse movement of the series of attention locations within the space.

As illustrated in FIGS. 1-2, one or more audio capabilities of an end user audio system can be discovered, and one or more content items in the content item data store can be retrieved based on audio spatial complexity scores associated with the one or more content items and the one or more audio capabilities.

As illustrated in FIG. 3, a visual complexity score of the content item can be determined. Determining the audio spatial complexity score may further include determining the audio spatial complexity score based on the visual complexity score.

FIG. 9 illustrates audio spatial complexity scoring based on audio channels cross-correlation analysis, according to some embodiments of the disclosure. FIG. 9 illustrates method 900. In 902, a cross-correlation between audio channels of a content item may be determined. In some embodiments, pairwise cross-correlation of two audio channels are examined. In 904, audio spatial complexity score of the content item can be determined based on the cross-correlation. In 906, the audio spatial complexity score of the content item may be associated with the content item in a content item data store.

In some embodiments, the cross-correlation analysis in method 900 is performed to understand the cross-correlation of the front audio signal(s) and rear audio signal(s). High correlation between the front and rear indicates low audio spatial complexity. Low correlation between the front and rear indicates high audio spatial complexity. The audio channels can include a front audio channel and a back audio channel. In one example, the audio channels include a front left channel and rear left channel. In another example, the audio channels include a front right channel and rear right channel.

In some embodiments, the cross-correlation analysis in method 900 is performed using frequency domain content of the audio channels to advantageously examine the cross-correlation of audio content across different frequencies and time-lag. For instance, a first short-time frequency transform (e.g., STFT) of a first audio channel of the audio channels and a second short-time frequency transform (e.g., STFT) of a second audio channel of the audio channels. Determining the cross-correlation can include determining a cross-correlation matrix of the first short-time frequency transform and the second short-time frequency transform. The first short-time frequency transform may include a two-dimensional representation of the first audio channel where one dimension represents time, and the other dimension represents frequency content at a particular time. The second short-time frequency transform may include a two-dimensional representation of the first audio channel where one dimension represents time, and the other dimension represents frequency content at a particular time. The cross-correlation matrix of the first short-time frequency transform and the second short-time frequency transform may include elements at (i, j). An element at (i, j) may represent a correlation between the first audio channel at time i, and the second audio channel at time j. High values in the cross-correlation matrix may indicate high correlation/similarity of the two audio channels at the specific time-lag. The diagonal of the cross-correlation matrix may indicate strong high correlation/similarity of the two audio channels at the same time.

In some embodiments, the cross-correlation matrix may undergo eigenvalue decomposition. Determining the audio spatial complexity score based on the cross-correlation may include performing eigenvalue decomposition on the cross-correlation matrix to determine a plurality of eigenvalues and a plurality of eigenvectors.

Audio spatial complexity score may be determined based on the eigenvalues. The presence of high eigenvalues may indicate strong correlation between the two audio channels. An audio spatial complexity score may be determined based on the presence of high eigenvalues.

Audio spatial complexity score based on the eigenvectors. Eigenvectors may include information about spatial-frequency patterns in the space, such as direction sound objects or attention locations. Eigenvectors associated with high eigenvalues may correspond to dominant attention locations or acoustic paths. An audio spatial complexity score may be determined based on an attention location encoded by an eigenvector with a high eigenvalue.

In some cases, higher order analysis of the evolution or changes in eigenvector structures (e.g., examining how eigenvectors associated with high eigenvalues are moving) obtained from multiple cross-correlation matrices obtained from overlapping or consecutive time windows may be performed. Further eigenvectors, such as eigenvectors associated with high eigenvalues, can be determined based on a further cross-correlation matrix of a third short-time frequency transform of the first audio channel for a further time window (generated based on a different time window of audio content than the time window of audio content used to generate the first short-time frequency transform) and a fourth short-time frequency transform of the second audio channel for the further time window (generated based on a different time window of audio content than the time window of audio content used to generate the second short-time frequency transform). The eigenvectors associated with high eigenvalues (principal eigenvectors) of a first cross-correlation matrix and eigenvectors associated with high eigenvalues (principal eigenvectors) of a second cross-correlation matrix can be compared to determine movement of attention locations. Gradual changes or shifts in the principal eigenvectors for a series of cross-correlation matrices may indicate smooth movement of attention locations. Sudden changes in the principal eigenvectors for a series of cross-correlation matrices may indicate fast movement of attention locations. The principal eigenvectors may be used to track attention locations across the duration of the content item, and properties of the attention locations can be inferred. The attention locations can be analyzed to determine an audio spatial complexity score using any one of the algorithms described herein.

As illustrated in FIGS. 1-2, one or more audio capabilities of an end user audio system can be discovered, and one or more content items in the content item data store can be retrieved based on audio spatial complexity scores associated with the one or more content items and the one or more audio capabilities.

As illustrated in FIG. 3, a visual complexity score of the content item can be determined. Determining the audio spatial complexity score may further include determining the audio spatial complexity score based on the visual complexity score.

FIG. 10 illustrates audio spatial complexity scoring based on audio object analysis, according to some embodiments of the disclosure. FIG. 10 illustrates method 1000. In 1002, an entropy of audio object locations of a content item can be determined. One or more other metrics besides entropy may be determined to assess movement and/or variation in audio object locations. In 1004, an audio spatial complexity score may be determined based on the entropy of the audio object locations. In 1006, the audio spatial complexity score may be associated with the content item in a content item datastore.

FIG. 11 illustrates a content item having exemplary audio spatial complexity scores and visual complexity scores, according to some embodiments of the disclosure. Audio spatial complexity scoring 182 of FIG. 3 may apply one or more algorithms to determine an audio spatial complexity score S₁ of segment 402 and associate the audio spatial complexity score S₁ to segment 402 in a content item data store. Visual content analysis 310 may determine a visual complexity score V₁ of segment 402. Audio spatial complexity scoring 182 may apply one or more algorithms to determine an audio spatial complexity score S₂ of segment 404 and associate the audio spatial complexity score S₂ to segment 404 in the content item data store. Visual content analysis 310 may determine a visual complexity score V₂ of segment 404. Audio spatial complexity scoring 182 may apply one or more algorithms to determine an audio spatial complexity score S₃ of segment 406 and associate the audio spatial complexity score S₃ to segment 406 in the content item data store. Visual content analysis 310 may determine a visual complexity score V₃ of segment 406. Audio spatial complexity scoring 182 may apply one or more algorithms to determine an audio spatial complexity score S₄ of segment 408 and associate the audio spatial complexity score S₄ to segment 408 in the content item data store. Visual content analysis 310 may determine a visual complexity score V₄ of segment 408. In some embodiments, composite audio spatial complexity score calculator 316 of FIG. 3 may calculate composite audio spatial complexity scores based on the audio spatial complexity scores of the segments, S₁, S₂, S₃, and S₄, and the visual complexity scores of segments, S₁, S₂, S₃, and S₄. In some embodiments, full audio spatial complexity score calculator 314 of FIG. 3 may determine a full audio spatial complexity score SFULL based on or as a function of the audio spatial complexity scores of the segments, S₁, S₂, S₃, and S₄ and the visual complexity scores of segments, S₁, S₂, S₃, and S₄.

### Multi-Modal Complexity Scores

Content items may be evaluated based on other metrics for complexity, such as multi-modal complexity. Content items may include multiple modalities such as: audio, video/visual, scents, vibrations, low-frequency sounds, movements, moving seat/chair, vibrating seat/chair, vibrating headset or other wearable, haptic output, water misting/spraying/squirting, fan blowing, fan gusts, fog, lighting, stereo vision (different video for each eye), three-dimensional video, etc. Content items may have different signals that correspond to different modalities. A signal corresponding to a specific modality can cause an output to be generated/output according to the specific modality. For multi-modal content items, it is possible to measure multi-modal complexity of the content item based on how well the different modalities are cooperating together to deliver a multi-sensory experience. Multi-modal complexity can measure how synchronized the different modalities are. The measurement can be based on how synchronized multi-modal outputs are across different modalities. Cross-correlation of signals corresponding to different modalities can be used as an indicator for multi-modal complexity. One or more cross-correlations between different pairs of modalities can be used to produce a multi-modality complexity score for a content item. Higher cross-correlation can mean higher multi-modal complexity. Lower cross-correlation can mean lower multi-odal complexity.

### High Versus Low Values

Various passages herein describe high values and low values. In some cases, a high value may mean that the value is above a threshold, and a low value may mean that the value is below a threshold. The threshold may be fixed for a collection of content items. The threshold may be dependent on one or more factors or conditions (e.g., metadata of the content item, visual complexity score, length/duration of content item or segment of content item, etc.). In some cases, a high value may mean that the value is above a certain percentile of values observed for segments of a content item, and a low value may mean the value is below a certain percentile of values observed for segments of the content item. In some cases, a high value may mean that the value is above a certain percentile of values observed for a collection of content items, and a low value may mean the value is below a certain percentile of values observed for segments of a collection of content items.

Values as used herein may refer to numerical values, or discrete levels/labels that indicate position over a range of values.

### Exemplary Computing Device

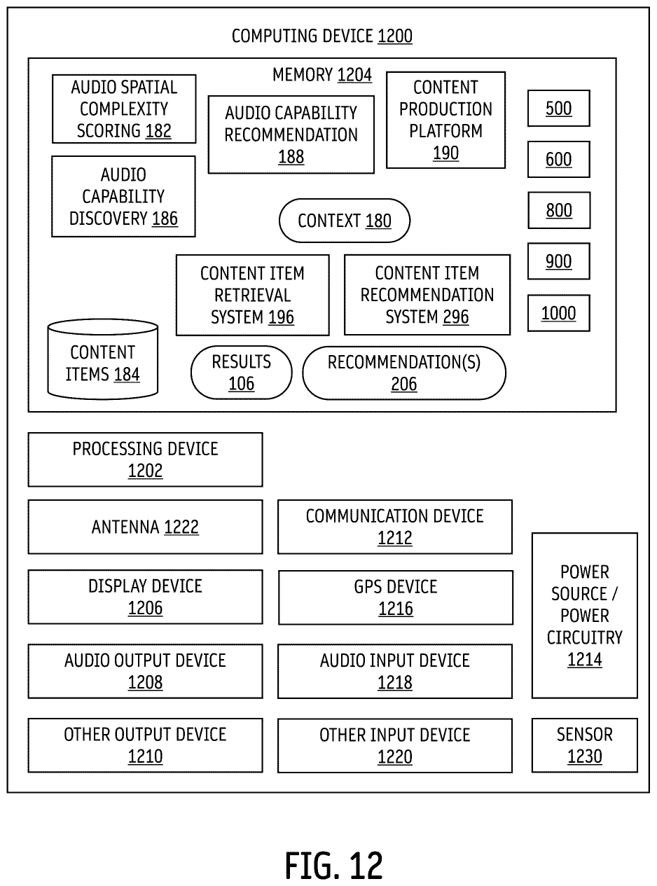

FIG. 12 is a block diagram of an exemplary computing device 1200, according to some embodiments of the disclosure. One or more computing devices 1200 may be used to implement the functionalities described with the FIGS. and herein. A number of components are illustrated in FIG. 12. as included in the computing device 1200, but any one or more of these components may be omitted or duplicated, as suitable for the application. In some embodiments, some or all of the components included in the computing device 1200 may be attached to one or more motherboards. In some embodiments, some or all of these components are fabricated onto a single system on a chip (SoC) die. Additionally, in various embodiments, the computing device 1200 may not include one or more of the components illustrated in FIG. 12, and the computing device 1200 may include interface circuitry for coupling to the one or more components. For example, the computing device 1200 may not include a display device 1206, and may include display device interface circuitry (e.g., a connector and driver circuitry) to which a display device 1206 may be coupled. In another set of examples, the computing device 1200 may not include an audio input device 1218 or an audio output device 1208 and may include audio input or output device interface circuitry (e.g., connectors and supporting circuitry) to which an audio input device 1218 or audio output device 1208 may be coupled.

The computing device 1200 may include a processing device 1202 (e.g., one or more processing devices, one or more of the same type of processing device, one or more of different types of processing device). The processing device 1202 may include electronic circuitry that process electronic data from data storage elements (e.g., registers, memory, resistors, capacitors, quantum bit cells) to transform that electronic data into other electronic data that may be stored in registers and/or memory. Examples of processing device 1202 may include a central processing unit (CPU), a graphical processing unit (GPU), a quantum processor, a machine learning processor, an artificial-intelligence processor, a neural network processor, an artificial-intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU), etc.

The computing device 1200 may include a memory 1204, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 1204 includes one or more non-transitory computer-readable storage media. In some embodiments, memory 1204 may include memory that shares a die with the processing device 1202.

In some embodiments, memory 1204 includes one or more non-transitory computer-readable media storing instructions executable to perform operations described with the FIGS. and herein, such as the methods and techniques illustrated in FIGS. 3-11, including method 500, method 600, method 800, method 900, and method 1000.

Memory 1204 may store instructions that encode one or more exemplary parts. Exemplary parts that may be encoded as instructions and stored in memory 1204 are depicted. Exemplary parts may include one or more components of system 100 of FIG. 1. Exemplary parts may include one or more components of system 200 of FIG. 2. Exemplary parts may include one or more components of audio spatial complexity scoring 182 of FIG. 3. The instructions stored in the one or more non-transitory computer-readable media may be executed by processing device 1202.

In some embodiments, memory 1204 may store data, e.g., data structures, binary data, bits, metadata, files, blobs, etc., as described with the FIGS. and herein. Exemplary data that may be stored in memory 1204 are depicted. Exemplary data may include one or more of, e.g., context 180, results 106, recommendations 206, and content items 184. Exemplary data may include audio spatial complexity scores. Exemplary data may include visual complexity scores.

In some embodiments, memory 1204 may store one or more machine learning models (and or parts thereof) that are used in at least content item retrieval system 196 of FIG. 1, content item recommendation system 296 of FIG. 2, and audio spatial complexity scoring 182 (e.g., a machine learning model in model 306). Memory 1204 may store one or more machine learning models of model 306. Memory 1204 may store training data for training the one or more machine learning models. Memory 1204 may store input data, output data, intermediate outputs, intermediate inputs of one or more machine learning models. Memory 1204 may store instructions to perform one or more operations of the machine learning model. Memory 1204 may store one or more parameters used by the machine learning model. Memory 1204 may store information that encodes how processing units of the machine learning model are connected with each other.

In some embodiments, the computing device 1200 may include a communication device 1212 (e.g., one or more communication devices). For example, the communication device 1212 may be configured for managing wired and/or wireless communications for the transfer of data to and from the computing device 1200. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1212 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 1212 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1212 may operate in accordance with other wireless protocols in other embodiments. The computing device 1200 may include an antenna 1222 to facilitate wireless communications and/or to receive other wireless communications (such as radio frequency transmissions). The computing device 1200 may include receiver circuits and/or transmitter circuits. In some embodiments, the communication device 1212 may manage wired communications, such as electrical, optical, or any other suitable communication protocols (e.g., the Ethernet). As noted above, the communication device 1212 may include multiple communication chips. For instance, a first communication device 1212 may be dedicated to shorter-range wireless communications such as Wi-Fi or Bluetooth, and a second communication device 1212 may be dedicated to longer-range wireless communications such as global positioning system (GPS), EDGE, GPRS, CDMA, WiMAX, LTE, EV-DO, or others. In some embodiments, a first communication device 1212 may be dedicated to wireless communications, and a second communication device 1212 may be dedicated to wired communications.

The computing device 1200 may include power source/power circuitry 1214. The power source/power circuitry 1214 may include one or more energy storage devices (e.g., batteries or capacitors) and/or circuitry for coupling components of the computing device 1200 to an energy source separate from the computing device 1200 (e.g., DC power, AC power, etc.).

The computing device 1200 may include a display device 1206 (or corresponding interface circuitry, as discussed above). The display device 1206 may include any visual indicators, such as a heads-up display, a computer monitor, a projector, a touchscreen display, a liquid crystal display (LCD), a light-emitting diode display, or a flat panel display, for example.

The computing device 1200 may include an audio output device 1208 (or corresponding interface circuitry, as discussed above). The audio output device 1208 may include any device that generates an audible indicator, such as speakers, headsets, or earbuds, for example.

The computing device 1200 may include an audio input device 1218 (or corresponding interface circuitry, as discussed above). The audio input device 1218 may include any device that generates a signal representative of a sound, such as microphones, microphone arrays, or digital instruments (e.g., instruments having a musical instrument digital interface (MIDI) output).

The computing device 1200 may include a GPS device 1216 (or corresponding interface circuitry, as discussed above). The GPS device 1216 may be in communication with a satellite-based system and may receive a location of the computing device 1200, as known in the art.

The computing device 1200 may include a sensor 1230 (or one or more sensors). The computing device 1200 may include corresponding interface circuitry, as discussed above). Sensor 1230 may sense physical phenomenon and translate the physical phenomenon into electrical signals that can be processed by, e.g., processing device 1202. Examples of sensor 1230 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 1200 may include another output device 1210 (or corresponding interface circuitry, as discussed above). Examples of the other output device 1210 may include an audio codec, a video codec, a printer, a wired or wireless transmitter for providing information to other devices, haptic output device, gas output device, vibrational output device, lighting output device, home automation controller, or an additional storage device.

The computing device 1200 may include another input device 1220 (or corresponding interface circuitry, as discussed above). Examples of the other input device 1220 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1200 may have any desired form factor, such as a handheld or mobile computer system (e.g., a cell phone, a smart phone, a mobile internet device, a music player, a tablet computer, a laptop computer, a netbook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device (e.g., light bulb, cable, power plug, power source, lighting system, audio assistant, audio speaker, smart home device, smart thermostat, camera monitor device, sensor device, smart home doorbell, motion sensor device), a virtual reality system, an augmented reality system, a mixed reality system, or a wearable computer system. In some embodiments, the computing device 1200 may be any other electronic device that processes data.

### Select Examples

Example 1 provides a method, including determining attention locations over time based on audio channels of a content item; determining audio spatial complexity score of the content item based on the attention locations; and associating the audio spatial complexity score of the content item with the content item in a content item data store.

Example 2 provides the method of example 1, where determining the attention locations includes determining, for a particular cell in a grid having cells in a space, a combined energy of the audio channels at the particular cell at a particular time; and setting a cell having a highest combined energy among the cells of the grid as an attention location for the particular time.

Example 3 provides the method of example 2, where determining the combined energy of the audio channels at the particular cell at the particular time includes determining a first root mean squared measurement of a first audio channel at the particular time and at the particular cell; determining a second root mean squared measurement of a second audio channel at the particular time and at the particular cell; and determining the combined energy based on the first root mean squared measurement and the second root mean squared measurement.

Example 4 provides the method of example 2 or 3, where determining the combined energy of the audio channels at the particular cell at the particular time includes determining a first loudness units full scale measurement of a first audio channel at the particular time and at the particular cell; determining a second loudness units full scale measurement of a second audio channel at the particular time and at the particular cell; and determining the combined energy based on the first loudness units full scale measurement and the second loudness units full scale measurement.

Example 5 provides the method of any one of examples 2-4, where determining the combined energy of the audio channels at the particular cell at the particular time includes determining a first decibels relative to full scale measurement of a first audio channel at the particular time and at the particular cell; determining a second decibels relative to full scale measurement of a second audio channel at the particular time and at the particular cell; and determining the combined energy based on the first decibels relative to full scale measurement and the second decibels relative to full scale measurement.

Example 6 provides the method of any one of examples 2-4, where determining the combined energy of the audio channels at the particular cell at the particular time includes determining a first source location of a first audio channel of the audio channels in the space; determining a second source location of a second audio channel of the audio channels in the space; and determining the combined energy based on a first distance between a center point of the particular cell to the first source location and a second distance between the center point of the particular cell to the second source location.

Example 7 provides the method of any one of examples 1-6, where determining the audio spatial complexity score includes determining an entropy of the attention locations; and determining the audio spatial complexity score based on the entropy.

Example 8 provides the method of any one of examples 1-7, where determining the audio spatial complexity score includes determining a variance of the attention locations; and determining the audio spatial complexity score based on the variance.

Example 9 provides the method of any one of examples 1-8, where determining the audio spatial complexity score includes determining coordinates of the attention locations along a first dimension; and determining the audio spatial complexity score based on a number of threshold crossings of the coordinates along the first dimension.

Example 10 provides the method of any one of examples 1-9, further including discovering one or more audio capabilities of an end user audio system; and retrieving one or more content items in the content item data store based on audio spatial complexity scores associated with the one or more content items and the one or more audio capabilities.

Example 11 provides the method of any one of examples 1-10, further including determining a visual complexity score of the content item; where determining the audio spatial complexity score further includes determining the audio spatial complexity score based on the visual complexity score.

Example 12 provides a method, including determining a cross-correlation between audio channels of a content item; determining audio spatial complexity score of the content item based on the cross-correlation; and associating the audio spatial complexity score of the content item with the content item in a content item data store.

Example 13 provides the method of example 12, where the audio channels include a front audio channel and a back audio channel.

Example 14 provides the method of example 12 or 13, where determining the cross-correlation between the audio channels of the content item includes determining a first short-time frequency transform of a first audio channel of the audio channels; determining a second short-time frequency transform of a second audio channel of the audio channels; and determining the cross-correlation includes determining a cross-correlation matrix of the first short-time frequency transform and the second short-time frequency transform.

Example 15 provides the method of example 14, where determining the audio spatial complexity score based on the cross-correlation includes performing eigenvalue decomposition on the cross-correlation matrix to determine a plurality of eigenvalues and a plurality of eigenvectors.

Example 16 provides the method of example 15, where determining the audio spatial complexity score based on the cross-correlation includes determining the audio spatial complexity score based on the plurality of eigenvalues.

Example 17 provides the method of example 15 or 16, where determining the audio spatial complexity score based on the cross-correlation includes determining the audio spatial complexity score based on the plurality of eigenvectors.

Example 18 provides the method of any one of examples 12-17, further including discovering one or more audio capabilities of an end user audio system; and retrieving one or more content items in the content item data store based on audio spatial complexity scores associated with the one or more content items and the one or more audio capabilities.

Example 19 provides the method of any one of examples 12-18, further including determining a visual complexity score of the content item; where determining the audio spatial complexity score further includes determining the audio spatial complexity score based on the visual complexity score.

Example 20 provides one or more non-transitory computer-readable media storing instructions that, when executed by one or more processors, cause the one or more processors to: determine attention locations over time based on audio channels of a content item; determine audio spatial complexity score of the content item based on the attention locations; and associate the audio spatial complexity score of the content item with the content item in a content item data store.

Example 21 provides the one or more non-transitory computer-readable media of example 20, where determining the attention locations includes determining, for a particular cell in a grid having cells in a space, a combined energy of the audio channels at the particular cell at a particular time; and setting a cell having a highest combined energy among the cells of the grid as an attention location for the particular time.

Example 22 provides the one or more non-transitory computer-readable media of example 21, where determining the combined energy of the audio channels at the particular cell at the particular time includes determining a first root mean squared measurement of a first audio channel at the particular time and at the particular cell; determining a second root mean squared measurement of a second audio channel at the particular time and at the particular cell; and determining the combined energy based on the first root mean squared measurement and the second root mean squared measurement.

Example 23 provides the one or more non-transitory computer-readable media of any one of examples 21-22, where determining the combined energy of the audio channels at the particular cell at the particular time includes determining a first loudness units full scale measurement of a first audio channel at the particular time and at the particular cell; determining a second loudness units full scale measurement of a second audio channel at the particular time and at the particular cell; and determining the combined energy based on the first loudness units full scale measurement and the second loudness units full scale measurement.

Example 24 provides the one or more non-transitory computer-readable media of any one of examples 21-23, where determining the combined energy of the audio channels at the particular cell at the particular time includes determining a first decibels relative to full scale measurement of a first audio channel at the particular time and at the particular cell; determining a second decibels relative to full scale measurement of a second audio channel at the particular time and at the particular cell; and determining the combined energy based on the first decibels relative to full scale measurement and the second decibels relative to full scale measurement.

Example 25 provides the one or more non-transitory computer-readable media of any one of examples 21-23, where determining the combined energy of the audio channels at the particular cell at the particular time includes determining a first source location of a first audio channel of the audio channels in the space; determining a second source location of a second audio channel of the audio channels in the space; and determining the combined energy based on a first distance between a center point of the particular cell to the first source location and a second distance between the center point of the particular cell to the second source location.

Example 26 provides the one or more non-transitory computer-readable media of any one of examples 20-25, where determining the audio spatial complexity score includes determining an entropy of the attention locations; and determining the audio spatial complexity score based on the entropy.

Example 27 provides the one or more non-transitory computer-readable media of any one of examples 20-26, where determining the audio spatial complexity score includes determining a variance of the attention locations; and determining the audio spatial complexity score based on the variance.

Example 28 provides the one or more non-transitory computer-readable media of any one of examples 20-27, where determining the audio spatial complexity score includes determining coordinates of the attention locations along a first dimension; and determining the audio spatial complexity score based on a number of threshold crossings of the coordinates along the first dimension.

Example 29 provides the one or more non-transitory computer-readable media of any one of examples 20-28, where the instructions further cause the one or more processors to: discover one or more audio capabilities of an end user audio system; and retrieve one or more content items in the content item data store based on audio spatial complexity scores associated with the one or more content items and the one or more audio capabilities.

Example 30 provides the one or more non-transitory computer-readable media of any one of examples 20-29, where the instructions further cause the one or more processors to: determine a visual complexity score of the content item; where determining the audio spatial complexity score further includes determining the audio spatial complexity score based on the visual complexity score.

Example 31 provides one or more non-transitory computer-readable media storing instructions that, when executed by one or more processors, cause the one or more processors to: determine a cross-correlation between audio channels of a content item; determine audio spatial complexity score of the content item based on the cross-correlation; and associate the audio spatial complexity score of the content item with the content item in a content item data store.

Example 32 provides the one or more non-transitory computer-readable media of example 31, where the audio channels include a front audio channel and a back audio channel.

Example 33 provides the one or more non-transitory computer-readable media of example 31 or 32, where determining the cross-correlation between the audio channels of the content item includes determining a first short-time frequency transform of a first audio channel of the audio channels; determining a second short-time frequency transform of a second audio channel of the audio channels; and determining the cross-correlation includes determining a cross-correlation matrix of the first short-time frequency transform and the second short-time frequency transform.

Example 34 provides the one or more non-transitory computer-readable media of example 33, where determining the audio spatial complexity score based on the cross-correlation includes performing eigenvalue decomposition on the cross-correlation matrix to determine a plurality of eigenvalues and a plurality of eigenvectors.

Example 35 provides the one or more non-transitory computer-readable media of example 34, where determining the audio spatial complexity score based on the cross-correlation includes determining the audio spatial complexity score based on the plurality of eigenvalues.

Example 36 provides the one or more non-transitory computer-readable media of example 34 or 35, where determining the audio spatial complexity score based on the cross-correlation includes determining the audio spatial complexity score based on the plurality of eigenvectors.

Example 37 provides the one or more non-transitory computer-readable media of any one of examples 31-36, where the instructions further cause the one or more processors to: discover one or more audio capabilities of an end user audio system; and retrieve one or more content items in the content item data store based on audio spatial complexity scores associated with the one or more content items and the one or more audio capabilities.

Example 38 provides the one or more non-transitory computer-readable media of any one of examples 31-37, where the instructions further cause the one or more processors to: determine a visual complexity score of the content item; where determining the audio spatial complexity score further includes determining the audio spatial complexity score based on the visual complexity score.

Example 39 provides a computer-implemented system, including one or more processors, and one or more non-transitory computer-readable media storing instructions that, when executed by the one or more processors, cause the one or more processors to: determine attention locations over time based on audio channels of a content item; determine audio spatial complexity score of the content item based on the attention locations; and associate the audio spatial complexity score of the content item with the content item in a content item data store.

Example 40 provides the computer-implemented system of example 39, where determining the attention locations includes determining, for a particular cell in a grid having cells in a space, a combined energy of the audio channels at the particular cell at a particular time; and setting a cell having a highest combined energy among the cells of the grid as an attention location for the particular time.

Example 41 provides the computer-implemented system of example 40, where determining the combined energy of the audio channels at the particular cell at the particular time includes determining a first root mean squared measurement of a first audio channel at the particular time and at the particular cell; determining a second root mean squared measurement of a second audio channel at the particular time and at the particular cell; and determining the combined energy based on the first root mean squared measurement and the second root mean squared measurement.

Example 42 provides the computer-implemented system of any one of examples 40-41, where determining the combined energy of the audio channels at the particular cell at the particular time includes determining a first loudness units full scale measurement of a first audio channel at the particular time and at the particular cell; determining a second loudness units full scale measurement of a second audio channel at the particular time and at the particular cell; and determining the combined energy based on the first loudness units full scale measurement and the second loudness units full scale measurement.

Example 43 provides the computer-implemented system of any one of examples 40-42, where determining the combined energy of the audio channels at the particular cell at the particular time includes determining a first decibels relative to full scale measurement of a first audio channel at the particular time and at the particular cell; determining a second decibels relative to full scale measurement of a second audio channel at the particular time and at the particular cell; and determining the combined energy based on the first decibels relative to full scale measurement and the second decibels relative to full scale measurement.

Example 44 provides the computer-implemented system of any one of examples 40-42, where determining the combined energy of the audio channels at the particular cell at the particular time includes determining a first source location of a first audio channel of the audio channels in the space; determining a second source location of a second audio channel of the audio channels in the space; and determining the combined energy based on a first distance between a center point of the particular cell to the first source location and a second distance between the center point of the particular cell to the second source location.

Example 45 provides the computer-implemented system of any one of examples 39-44, where determining the audio spatial complexity score includes determining an entropy of the attention locations; and determining the audio spatial complexity score based on the entropy.

Example 46 provides the computer-implemented system of any one of examples 39-45, where determining the audio spatial complexity score includes determining a variance of the attention locations; and determining the audio spatial complexity score based on the variance.

Example 47 provides the computer-implemented system of any one of examples 39-46, where determining the audio spatial complexity score includes determining coordinates of the attention locations along a first dimension; and determining the audio spatial complexity score based on a number of threshold crossings of the coordinates along the first dimension.

Example 48 provides the computer-implemented system of any one of examples 39-47, where the instructions further cause the one or more processors to: discover one or more audio capabilities of an end user audio system; and retrieve one or more content items in the content item data store based on audio spatial complexity scores associated with the one or more content items and the one or more audio capabilities.

Example 49 provides the computer-implemented system of any one of examples 39-48, where the instructions further cause the one or more processors to: determine a visual complexity score of the content item; where determining the audio spatial complexity score further includes determining the audio spatial complexity score based on the visual complexity score.

Example 50 provides a computer-implemented system, including one or more processors, and one or more non-transitory computer-readable media storing instructions that, when executed by the one or more processors, cause the one or more processors to: determine a cross-correlation between audio channels of a content item; determine audio spatial complexity score of the content item based on the cross-correlation; and associate the audio spatial complexity score of the content item with the content item in a content item data store.

Example 51 provides the computer-implemented system of example 50, where the audio channels include a front audio channel and a back audio channel.

Example 52 provides the computer-implemented system of example 50 or 51, where determining the cross-correlation between the audio channels of the content item includes determining a first short-time frequency transform of a first audio channel of the audio channels; determining a second short-time frequency transform of a second audio channel of the audio channels; and determining the cross-correlation includes determining a cross-correlation matrix of the first short-time frequency transform and the second short-time frequency transform.

Example 53 provides the computer-implemented system of example 52, where determining the audio spatial complexity score based on the cross-correlation includes performing eigenvalue decomposition on the cross-correlation matrix to determine a plurality of eigenvalues and a plurality of eigenvectors.

Example 54 provides the computer-implemented system of example 53, where determining the audio spatial complexity score based on the cross-correlation includes determining the audio spatial complexity score based on the plurality of eigenvalues.

Example 55 provides the computer-implemented system of example 53 or 54, where determining the audio spatial complexity score based on the cross-correlation includes determining the audio spatial complexity score based on the plurality of eigenvectors.

Example 56 provides the computer-implemented system of any one of examples 50-55, where the instructions further cause the one or more processors to: discover one or more audio capabilities of an end user audio system; and retrieve one or more content items in the content item data store based on audio spatial complexity scores associated with the one or more content items and the one or more audio capabilities.

Example 57 provides the computer-implemented system of any one of examples 50-56, where the instructions further cause the one or more processors to: determine a visual complexity score of the content item; where determining the audio spatial complexity score further includes determining the audio spatial complexity score based on the visual complexity score.

Example A provides an apparatus comprising means to carry out or means for carrying out any one of the computer-implemented methods provided in examples 1-19 and methods described herein.

Example B provides a computer-implemented system comprising one or more components illustrated in FIG. 1 to perform operations described herein.

Example C provides a computer-implemented system comprising one or more components illustrated in FIG. 2 to perform operations described herein.

Example D provides audio spatial complexity scoring comprising one or more components illustrated in FIG. 3 to perform operations described herein.

Example E provides a computing device comprising one or more components illustrated in FIG. 12 to perform operations described herein.

### Variations and Other Notes

Although the operations of the example methods shown in and described with reference to the FIGS. are illustrated as occurring once each and in a particular order, it will be recognized that the operations may be performed in any suitable order and repeated as desired. Additionally, one or more operations may be performed in parallel. Furthermore, the operations illustrated in the FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A method, comprising:
determining attention locations over time based on audio channels of a content item;
determining audio spatial complexity score of the content item based on the attention locations; and
associating the audio spatial complexity score of the content item with the content item in a content item data store.

2. The method of claim 1, wherein determining the attention locations comprises:
determining, for a particular cell in a grid having cells in a space, a combined energy of the audio channels at the particular cell at a particular time; and
setting a cell having a highest combined energy among the cells of the grid as an attention location for the particular time.

3. The method of claim 2, wherein determining the combined energy of the audio channels at the particular cell at the particular time comprises:
determining a first root mean squared measurement of a first audio channel at the particular time and at the particular cell;
determining a second root mean squared measurement of a second audio channel at the particular time and at the particular cell; and
determining the combined energy based on the first root mean squared measurement and the second root mean squared measurement.

4. The method of claim 2, wherein determining the combined energy of the audio channels at the particular cell at the particular time comprises:
determining a first loudness units full scale measurement of a first audio channel at the particular time and at the particular cell;
determining a second loudness units full scale measurement of a second audio channel at the particular time and at the particular cell; and
determining the combined energy based on the first loudness units full scale measurement and the second loudness units full scale measurement.

5. The method of claim 2, wherein determining the combined energy of the audio channels at the particular cell at the particular time comprises:
determining a first decibels relative to full scale measurement of a first audio channel at the particular time and at the particular cell;
determining a second decibels relative to full scale measurement of a second audio channel at the particular time and at the particular cell; and
determining the combined energy based on the first decibels relative to full scale measurement and the second decibels relative to full scale measurement.

6. The method of claim 2, wherein determining the combined energy of the audio channels at the particular cell at the particular time comprises:
determining a first source location of a first audio channel of the audio channels in the space;
determining a second source location of a second audio channel of the audio channels in the space; and
determining the combined energy based on a first distance between a center point of the particular cell to the first source location and a second distance between the center point of the particular cell to the second source location.

7. The method of claim 1, wherein determining the audio spatial complexity score comprises:
determining an entropy of the attention locations; and
determining the audio spatial complexity score based on the entropy.

8. The method of claim 1, wherein determining the audio spatial complexity score comprises:
determining a variance of the attention locations; and
determining the audio spatial complexity score based on the variance.

9. The method of claim 1, wherein determining the audio spatial complexity score comprises:
determining coordinates of the attention locations along a first dimension; and
determining the audio spatial complexity score based on a number of threshold crossings of the coordinates along the first dimension.

10. The method of claim 1, further comprising:
discovering one or more audio capabilities of an end user audio system; and
retrieving one or more content items in the content item data store based on audio spatial complexity scores associated with the one or more content items and the one or more audio capabilities.

11. The method of claim 1, further comprising:
determining a visual complexity score of the content item;
wherein determining the audio spatial complexity score further comprises determining the audio spatial complexity score based on the visual complexity score.

12. One or more non-transitory computer-readable media storing instructions that, when executed by one or more processors, cause the one or more processors to:
determine attention locations over time based on audio channels of a content item;
determine audio spatial complexity score of the content item based on the attention locations; and
associate the audio spatial complexity score of the content item with the content item in a content item data store.

13. The one or more non-transitory computer-readable media of claim 12, wherein determining the attention locations comprises:
determining, for a particular cell in a grid having cells in a space, a combined energy of the audio channels at the particular cell at a particular time; and
setting a cell having a highest combined energy among the cells of the grid as an attention location for the particular time.

14. The one or more non-transitory computer-readable media of claim 13, wherein determining the combined energy of the audio channels at the particular cell at the particular time comprises:
determining a first root mean squared measurement of a first audio channel at the particular time and at the particular cell;
determining a second root mean squared measurement of a second audio channel at the particular time and at the particular cell; and
determining the combined energy based on the first root mean squared measurement and the second root mean squared measurement.

15. The one or more non-transitory computer-readable media of claim 12, wherein determining the audio spatial complexity score comprises:
determining an entropy of the attention locations; and
determining the audio spatial complexity score based on the entropy.

16. The one or more non-transitory computer-readable media of claim 12, wherein determining the audio spatial complexity score comprises:
determining a variance of the attention locations; and
determining the audio spatial complexity score based on the variance.

17. The one or more non-transitory computer-readable media of claim 12, wherein determining the audio spatial complexity score comprises:
determining coordinates of the attention locations along a first dimension; and
determining the audio spatial complexity score based on a number of threshold crossings of the coordinates along the first dimension.

18. A computer-implemented system, comprising:
one or more processors, and
one or more non-transitory computer-readable media storing instructions that, when executed by the one or more processors, cause the one or more processors to:
determine a cross-correlation between audio channels of a content item;
determine audio spatial complexity score of the content item based on the cross-correlation; and
associate the audio spatial complexity score of the content item with the content item in a content item data store.

19. The computer-implemented system of claim 18, wherein the audio channels comprise a front audio channel and a back audio channel.

20. The computer-implemented system of claim 18, wherein:
determining the cross-correlation between the audio channels of the content item comprises:
determining a first short-time frequency transform of a first audio channel of the audio channels;
determining a second short-time frequency transform of a second audio channel of the audio channels; and
determining the cross-correlation comprises determining a cross-correlation matrix of the first short-time frequency transform and the second short-time frequency transform; and
determining the audio spatial complexity score based on the cross-correlation comprises:
performing eigenvalue decomposition on the cross-correlation matrix to determine a plurality of eigenvalues and a plurality of eigenvectors; and
determining the audio spatial complexity score based on one or more of: the plurality of eigenvalues and the plurality of eigenvectors.
